(19) United States
(12) Patent Application Publication
(10) Pub. No.: US 2009/0049723 A1
(43) Pub. Date: Feb. 26, 2009

(54) PRODUCT DISPLAY DESIGNATOR

(75) Inventor: Keith Arndt, New York, NY (US)

Correspondence Address: MICHAUD-DUFFY GROUP LLP, 306 INDUSTRIAL PARK ROAD, SUITE 206, MIDDLETOWN, CT, 06457, US

(73) Assignee: MECHTRONICS CORPORATION, White Plains, NY (US)

(21) Appl. No.: 12/196,456

(22) Filed: Aug. 22, 2008

Related U.S. Application Data
(60) Provisional application No. 60/957,237, filed on Aug. 22, 2007.

(51) Int. Cl. G09F 3/00

(52) U.S. Cl. 40/642.01

(57) ABSTRACT

A placard device for a product display system has a placard that includes a product information region and a featured information region. There is also an attachment device for mounting the placard on a product support device. A product display system includes the placard and a product support device such as a shelving system or a pegboard display system. For use with a pegboard display system, the placard device has a foot portion and a boom portion joined to the foot portion, wherein the placard is joined to the boom portion. A product display system can be created by associating one or more such placard devices with a product support device. In a display, products having common product species identifications may be grouped together.

### CROSS-REFERENCE TO RELATED APPLICATIONS

This patent application claims priority benefit under 35 U.S.C. § 119(e) of copending, U.S. Provisional Patent Application Ser. No. 60/957,237, filed Aug. 22, 2007, the disclosure of this U.S. patent application is incorporated by reference herein in its entirety.

### BACKGROUND OF THE INVENTION

1. Field of the Invention

This invention relates to merchandise and/or product display systems and, in particular, to reconfigurable product display systems.

2. Description of Related Art

In a retail environment, consumers wish to quickly locate a product that they desire from among other products in a display and to easily remove the desired product from the display. Retailers and consumers face several challenges regarding the display of products, because so many products resemble other products even though they are not substitutes for each other. In addition, retailers need to easily arrange and rearrange the products on the display for aesthetic purposes and/or to facilitate restocking the display.

Typically, a product package, for example, a package for a battery, has information on it to specifically identify the product contained therein. As discussed in U.S. Pat. No. 6,244,444, to Jacobus, et al., granted Jun. 12, 2001, entitled “Peggable Reclosable Battery Package,” the disclosure of which is incorporated by reference herein in its entirety, there are a number of battery types that are identified by voltage, current, and dimensional criteria. Most common among these battery types are round cell batteries, readily available sources of direct current packaged in cylindrical canisters. The round cells have been given letter designations and range, in physical size, from AAAA, AAA, AA, and C to D. Also commonly used in conventional consumer products is the non-cylindrical 9V battery. Battery manufacturers label their products and product packages according to the standard sizes AA, AAA, etc., and often design battery packages for preferred display systems. The standardization of battery sizes and properties allow consumers an ability to replace the batteries in their electronic devices from the stocks of thousands of retailers throughout the world, for example, convenience stores, hardware stores and electronic shops. However, the various kinds of batteries are often similarly packaged, and they are not interchangeable. Therefore, consumers must take care to precisely select the battery they need.

When a retailer offers a variety of batteries for sale, it is standard marketing practice to group the various types of batteries together in one area of a display. Retailers face an ongoing challenge to design battery displays that allow consumers to quickly find the batteries they need despite the similarity of battery packages of various size batteries. Such challenges are presented in the sale of other product lines that include similarly packaged but non-interchangeable products.

In general, a retailer uses a product display system that includes a product support device that has multiple locations for different products. The product display system also includes product designators (placard devices) to label the locations on the product support device where particular products are to be displayed, and to provide information about those products. The placard device includes a rectangular placard for displaying product information. Typically, the product information displayed on the rectangular placard includes, for example, the product's commercial name, UPC/SKU code, price, size, etc. Such information is used by retailers and consumers for purposes of stocking the display system, taking inventory and for providing pricing and other information to consumers. Consumers use product information on placards to locate desired products on the display system and to learn the retailer's price. To avoid customer confusion, errors in inventory control and other vagaries of retail sales practice, it is necessary for retailers to carefully compare the product information on a product package with the information on the placard to assure that the placard matches the product associated therewith. After a product display is initially set up, it may be necessary or desirable to replenish, rearrange, or move products in the display. During such activities, it is important to ensure that the placard devices and products associated therewith remain properly associated with each other. Retailers often prefer reconfigurable product display systems, that is, systems that include product support devices that are configured in various ways to permit variation in the placement of products thereon.

A basic type of reconfigurable product support device is a shelving system in which several shelves are supported on a frame. In typical use, a retailer places product designators on a shelf to label portions of the shelf for specific products. A shelving system may be reconfigurable in that it may allow for vertical adjustment of the shelves, so that the retailer may raise and/or lower one or more shelves on the frame to accommodate products of various sizes. A placard device for a shelving system may include a placard and an attachment device on which the placard is mounted. The attachment device may be adhesive, or a clip or other structure, for mounting at or on an outward edge of the shelf. For example, a conventional front-fence type placard device 130 for a shelf 132 is shown in FIG. 1A. The placard device 130 has an L-shaped configuration that includes a base 130a by which the placard device 130 is attached to the front of the shelf 132 by a screw 134. The placard device 130 has an upward-extending placard 130b for displaying product information.

Shelving systems offer limited options for product display and display rearrangement. For example, a shelf often holds more that one type of product, and often holds products of various sizes. Therefore, the shelf must be positioned to accommodate the largest (tallest) item on the shelf. As such, there is a significant amount of “dead” space above the other products on shelf. In addition, it is typically necessary to completely clear the shelf before it can be moved, which makes moving the shelf a tedious and/or time-consuming. Moreover, the number of positions provided on a shelving frame is limited. Shelving systems have other drawbacks as well. For example, as products are removed from the shelves by customers, the visual appeal of the product display declines. In some instances, customers remove and then replace products on the shelf, but place the products near the wrong product designators, making the display confusing for others as well as visually unappealing.

Another type of reconfigurable product display system that is known in the art is a pegboard display system, which includes, as the product support device, a perforated board (sometimes referred to as a “pegboard”) and pegs that are moveably mountable on the board. In use, products are suspended on the pegs. Pegboard display systems offer an improvement relative to shelving systems because the number of possible positions for a peg on the board is generally much greater in both horizontal and vertical directions than the number of possible positions for an adjustable shelf on a frame. Therefore, for a given vertical area of display, a pegboard display system offers the possibility of permitting a greater number of horizontal rows of products than a shelving system. In addition, there is much greater flexibility in creating a display for products of various sizes, so the retailer can easily avoid creating a display that has dead space in it.

Placard devices for product information are also used with pegboard display systems. For example, a placard device may include a placard mounted on a boom member, where the boom member is mountable on the pegboard above the product peg to provide information to the consumer and/or retailer about the product on the peg. A prior art peg and placard device combination 100 is shown in FIG. 1B. The combination 100 includes a standard product peg 110 having a hook end 112 for engaging perforations in a pegboard and an arm 114 extending from the hook end 112 for supporting products hanging thereon. A placard device 120 is removably mountable near the peg 110 so that the placard device 120 can be associated with the peg 110 and with any products on the peg 110. For a placard device 120 to be associated with the peg 110, the placard device 120 is the closest placard to the end of the peg 110. In this case, the placard device 120 includes a foot portion 122 that is configured to engage the hook end 112 of the peg 110 and a rectangular placard 124 on a distal end of a boom member 126. The boom member 126 extends from the foot portion 122 towards the end of the product peg 110. In this way, the placard device 120 is positioned so that as a product is slid past the end of the peg 110, the product information on the placard 124 can be compared to the product information on the product package or to the product itself. Similar placards are used with other type of product displays, such as shelves.

One battery package for use in a pegboard display system is shown in U.S. Pat. No. 5,823,350, to Ward, granted Oct. 20, 1998, entitled “Paperboard Security Battery Package,” the disclosure of which is incorporated by reference herein in its entirety. Typically, with the use of such packages, batteries of a common type are displayed in proximity to each other. For example, all the “AA” batteries stocked on a product display are typically on a common peg and are adjacent to packages “AA” batteries on another peg, such as in a single column or row of pegs.

As described above, display systems having associated product information placards are known in the art. For example, U.S. Pat. No. 4,343,405, to Virte, et al., granted Aug. 10, 1982, entitled “Universal Mountable Display Tray,” discloses a display tray for consumer products having a plurality of pivotable support means for securing the tray on various width slats and various “peg-board” type support walls. Space for a small rectangular information placard is provided at the end of the tray.

U.S. Pat. No. 6,244,444, to Jacobus, et al., granted Jun. 12, 2001, entitled “Peggable Reclosable Battery Package,” discloses a re-closable battery package that is designed for display on a pegboard.

U.S. Pat. No. 7,131,543, to Mason, granted Nov. 7, 2006, entitled “Display Device,” discloses a display device for modular merchandise units. The display device provides a series of shelves in a housing on a substantially flat base, with at least one wheel connected to the base. The shelves are permanently positioned in the housing.

Generally speaking, the rectangular prior art placards include so much information that consumers have difficultly in finding pertinent items of information, such as the product species, from among all other product information on the placard, to enable them to precisely select the product that they want.

The inventor has discovered that conventional product display systems do not adequately exhibit product information. For example, a need exists for a more visually apparent way of exhibiting product information and, in particular, distinctive features and/or characteristics of the products within the display. Retailers also need display systems that are reconfigurable and easy to use.

Based on the foregoing, it is the general object of this invention to provide a product display system that improves upon, or overcomes the problems and drawbacks of, prior art product display systems.

### SUMMARY OF THE INVENTION

The present invention resides in one aspect in a placard device. The placard device comprises a placard that includes a product information region and a featured information region, and an attachment device for mounting the placard on a product support device.

In another aspect, the invention provides a product display system that comprises the placard device in combination with a product support device such as a shelving system or a pegboard display system. In a particular embodiment wherein the product support device comprises a pegboard display system, the placard device comprises a foot portion and a boom portion joined to the foot portion, wherein the placard is joined to the boom portion.

According to another aspect, the invention provides a method of creating a product display system. The method comprises associating a placard device with a product support device, wherein the placard device comprises a placard that includes a product information region and a featured information region.

### BRIEF DESCRIPTION OF THE DRAWINGS

FIG. 1A is a perspective view of a product support self member and placard device according to the prior art;

FIG. 1B is an exploded perspective view of a product display peg and placard arm according to another embodiment of the prior art;

FIG. 2 is a plan view of a placard arm for use according to a particular aspect of the invention;

FIG. 3 is a view of the placard arm of FIG. 2, taken on line 3-3;

FIG. 4 is an exploded perspective view of a product display peg and placard arm for use according to a particular embodiment of the present invention;

FIG. 5 is a schematic elevation view of a battery pegboard display according to one aspect of the invention;

FIG. 6 is a schematic elevation view of the display of FIG. 5 in need of rearrangement;

FIG. 7 is a schematic elevation view of the display of FIG. 6 after rearrangement;

FIG. 8A depicts a plurality of the product display pegs and placard arms of FIG. 4 exhibiting a plurality of products of a line of products to prospective consumers; and

FIG. 8B depicts a plurality of prior art product display pegs and placard arms.

### DETAILED DESCRIPTION OF PREFERRED EMBODIMENTS

In one aspect of the present invention, a placard device for a product display system includes a placard having a product information region and a featured information region. The placard may be associated with a product support device, such as a pegboard display system, a shelving system, or the like, on which a product may be displayed. The invention enables customers seeking a product on the product support device to more easily find the specific product they want. The invention also enables retailers to more easily load products onto the product support device and rearrange products thereon than with prior art product display systems.

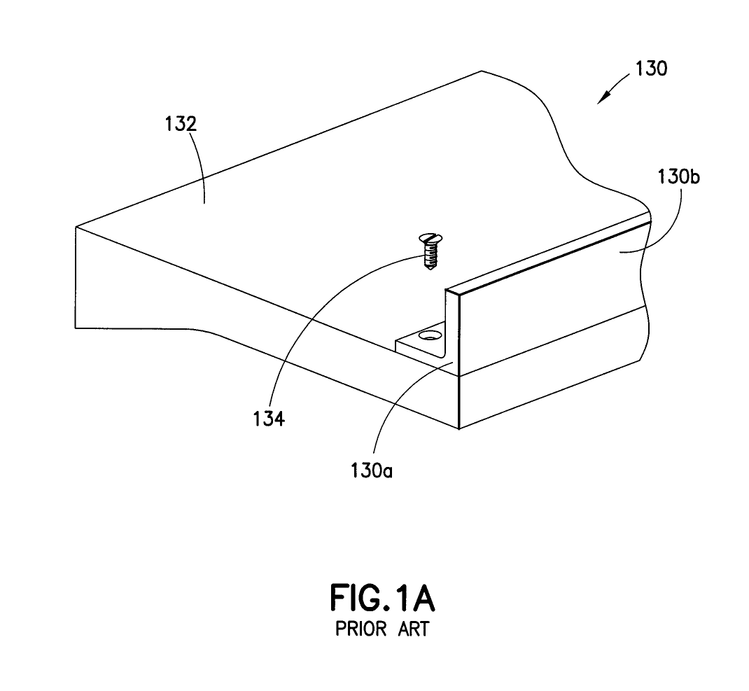

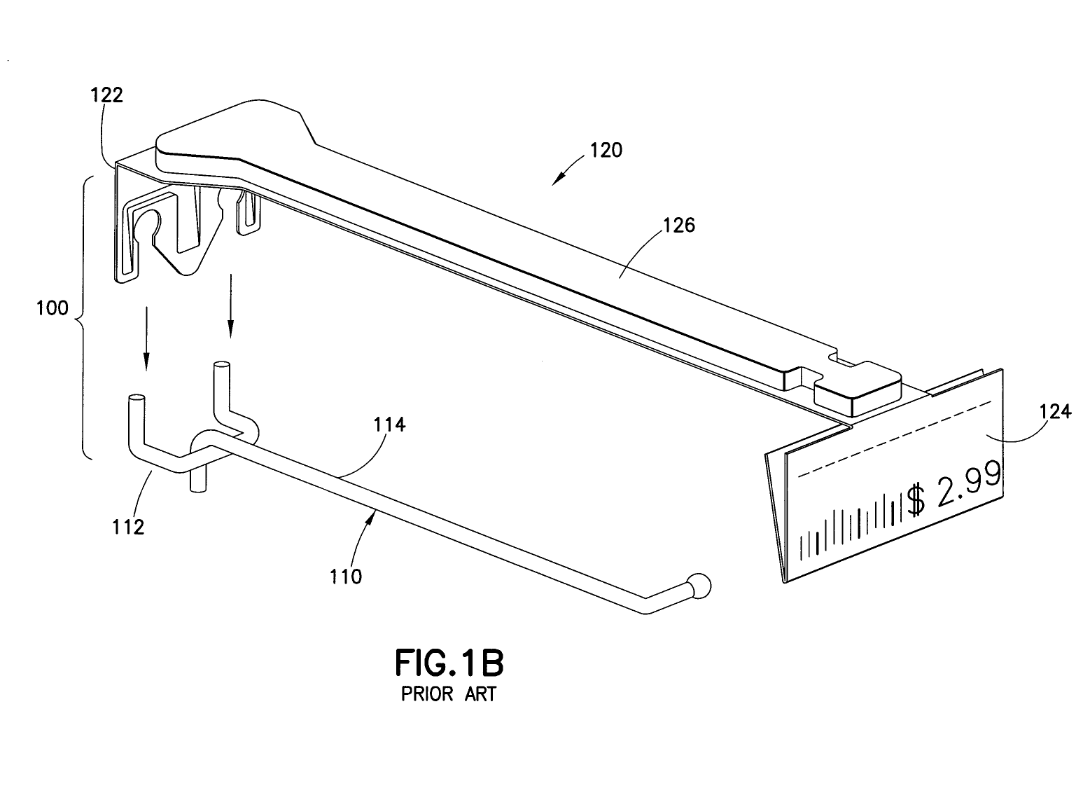

As noted above, a prior art placard device 100 for a pegboard display system is shown in FIG. 1B. The placard device 100 provides only a product information region 124 in the placard 100 at the distal end of the boom member 126. The product information region 124 is typically rectangular and displays numerous types of product information including, for example, the product UPC/SKU code, a scannable bar code, and textual information including the product name and price. With so much information on the product information region 124, it is often difficult for consumers to use the product information region 124 to locate the product they want from among the others on the same pegboard display. As discussed below, the most common information wanted is product species information (e.g., battery size or other properties of the product). In addition, great care must be exercised by the retailer when loading and re-loading product on the display, so that the product loaded on the peg matches the product identified on the product information region 124. Due to the quantity of information on the limited product information region 124, great care must also be taken in placing the pegs and placard arms on the pegboard to assure that like products are placed together, e.g., that all of the “AA” batteries are grouped together in a same area of the pegboard display system.

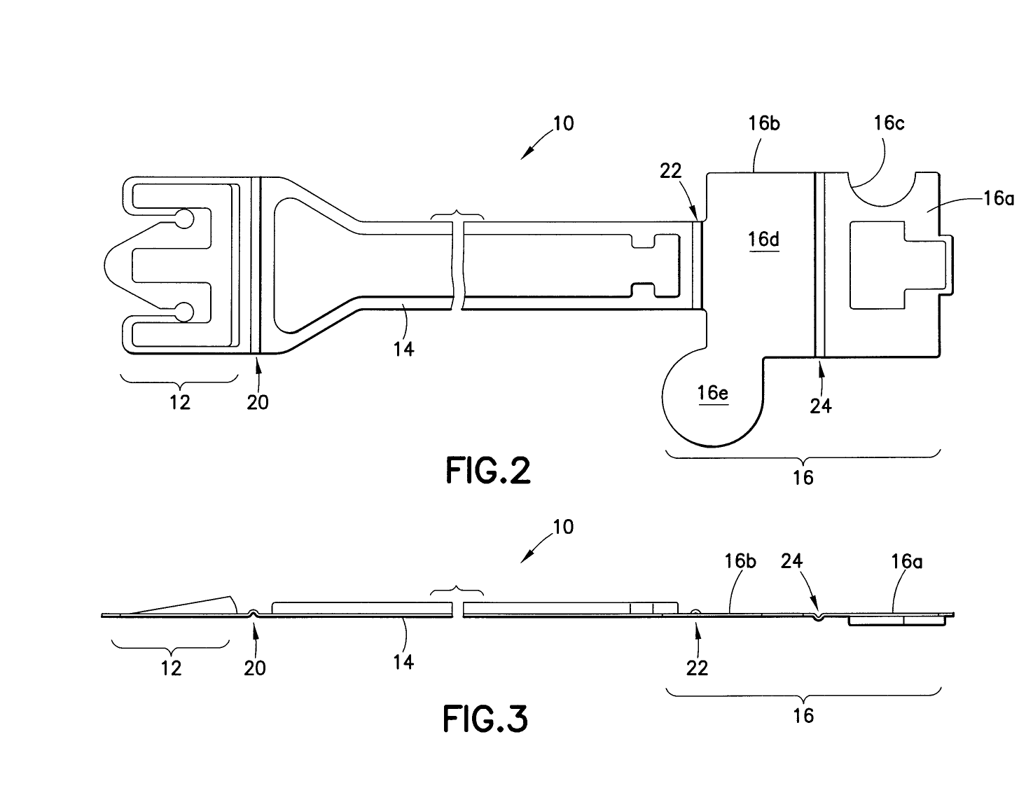

One aspect of the invention makes use of a novel placard configuration in a placard device. One embodiment of a placard device 10, in accordance with the present invention, is seen in FIG. 2 and FIG. 3. In one embodiment, the placard device 10 is formed from a moldable material in a molding process, e.g., an injection molding process, and comprises a foot portion 12, a boom portion 14 and a placard 16. The foot portion 12 is configured to be removably mountable on a pegboard near an associated peg. For example, the foot 12 is configured to engage a hook end 112 of a standard product peg (FIG. 1B). The boom 14 is joined to the foot 12 by a proximal hinge 20, and the placard 16 is joined to the boom 14 by a distal hinge 22. In one embodiment, the placard 16 has two parts joined together by a placard hinge 24. The hinged configuration of the placard allows for the creation of a placard sleeve by folding a rear portion 16a of the placard 16 against a front portion 16b. In one embodiment, the front portion 16b is transparent and of a suitably size for receiving a card bearing product information inserted into the placard sleeve. A cutout 16c in the rear portion 16a facilitates removal of the card so that the card can be replaced should the product information need to be updated or changed. While the placard sleeve is described as being formed by folding two parts (rear portion 16a and front portion 16b) of the placard 16, it should be appreciated that in one embodiment, the placard sleeve is formed as a one piece construction.

When the placard device 10 is mounted on a peg (e.g., peg 110) that is mounted on a pegboard, the foot 12 is disposed vertically. The boom 14 is angled from the foot by the proximal hinge 20 and extends from the pegboard, for example, above and along a length of the peg 110. The placard 16 is angled from the boom 14 by the distal hinge 22, is positioned near the distal end of the peg, and extends down so that information within the placard sleeve is visible about the distal end of the peg. As shown in FIG. 2, the placard 16 includes a rectangular product information region 16d. The rectangular product information region 16d is of a size suitable for displaying all the necessary product information required by consumers and the retailer for the various purposes of stocking the pegboard, taking inventory, providing pricing and other information to consumers, as is known in the art. In accordance with the present invention, the placard 16 also includes a featured information region 16e for prominently displaying a specific item of the product information, e.g., the product species. The species information of a product is that a feature or characteristic of each product in a line of products that is used by consumers in selecting a particular product from a full line of similar products. For example, a product species of a line of battery products is the battery size; the species of a line of shoe products is the shoe size, etc. The prominently displayed product information may also appear on the product package, but it might not, or it might be difficult to find upon causal or hurried inspection, so the featured information area 16e provides the consumer's (and the retailer's) a more useful presentation of the information. It should be appreciated that the featured information may also or alternatively include promotional information (e.g., a discount price) or other information for individually identifying a subset of products from a product line such as, for example, a low calorie food item from within a category of foods (or other nutritional value information), a product having a desirable product rating (e.g., a freshness or organic certification), and the like.

In accordance with the present invention, the featured information region 16e is configured to distinguish the region 16e from the product information region 16d. For example, in one embodiment illustrated in FIGS. 2-4, the product information region 16d is rectangular and the featured information region 16e is a substantially circular pendant disposed adjacent to the rectangular area 16d. It should be appreciated that it is within the scope of the present invention for the featured information region 16e to be configured as any other shape, color and the like, to distinguish the featured information region 16e from the product information region 16d. In one embodiment, the featured information region 16e includes one of a plurality of predetermined colors, where each color represents one of a plurality of species in a product line. For example, it is known to color code particular species of hearing aid batteries such that different sizes of hearing aid batteries may be identified by one or more of a color code and a numeric size code. It is within the scope of the present invention for the featured information region 16e to reflect one or more of the color codes and the numeric code of the hearing aid batteries such that different sizes of batteries can be more easily recognized by prospective consumers.

In accordance with the present invention, the featured information region 16e is used to prominently display the featured product information that individually identifies each species within the product line. The inventor has discovered that prominently displaying the species information is helpful to both the consumer and the retailer. For example, for a pegboard display of a line of battery packages, the featured information region 16e prominently displays particular battery sizes, “AA”, “AAA,” etc. The product species information may be displayed also in the rectangular product information region 16d, but the species information can be difficult to quickly discern amidst all the other information typically included on a product placard. The inventor has discovered that by providing a featured information area specifically for the prominent display of product species information, the use of the product placard is greatly improved.

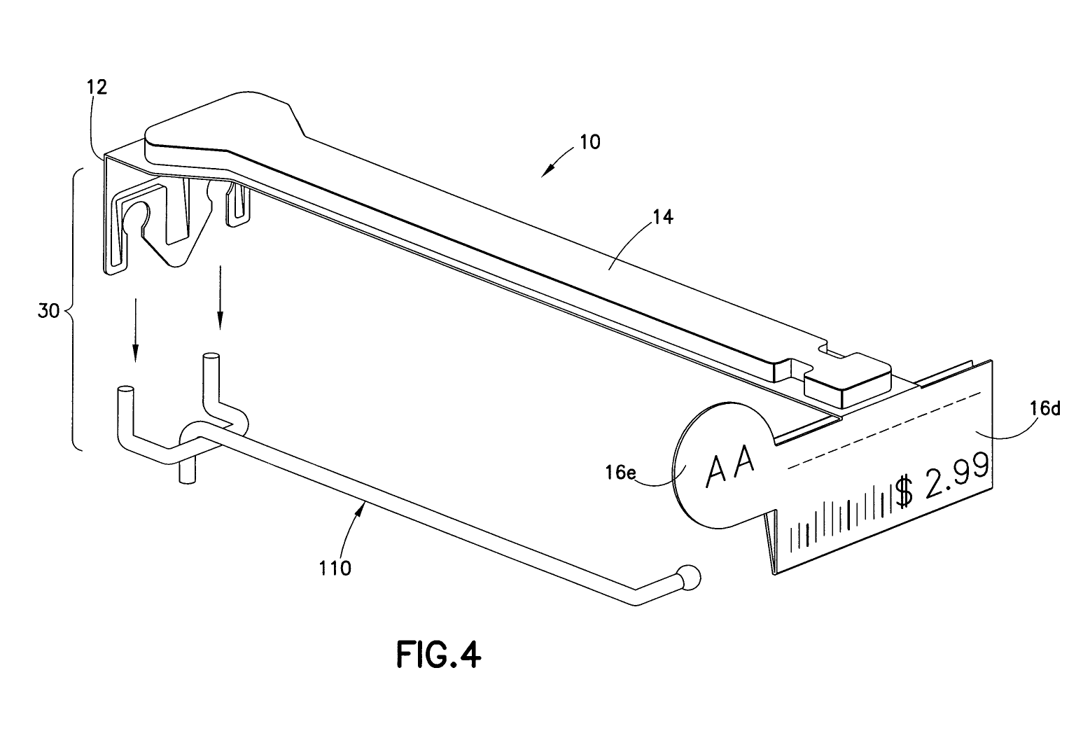

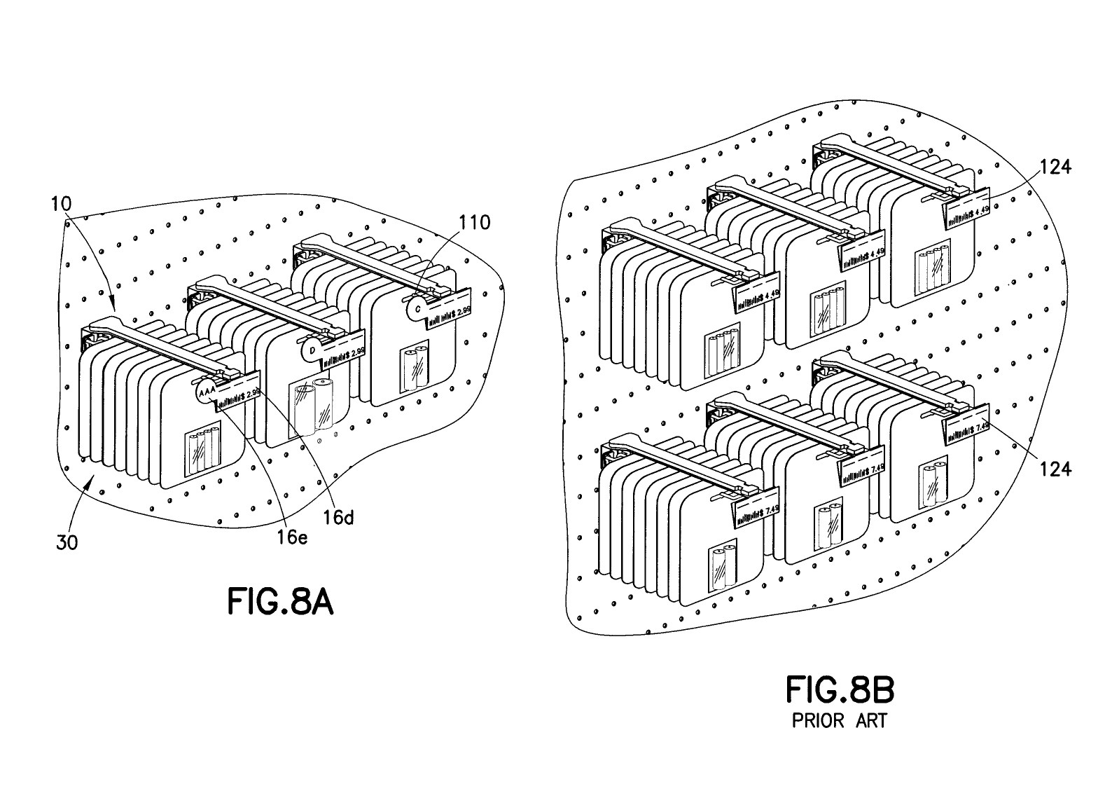

As seen in FIGS. 4 and 8A, the placard device 10 can be used with a standard product peg 110 to provide a novel peg display 30. By prominently displaying the product species on the featured information region 16e of the placard 16 and associating the placard device 10 with the peg 110, the use of the placard device 10 on a pegboard display system facilitates the retailer's task of stocking the peg with product and facilitates the consumer's task of selecting a desired product from within a line of products having differing features or characteristics. As shown in FIG. 8A, it is within the scope of the present invention for the featured information region 16e to be configured utilizing a different color scheme than is used for the product information region 16d to even further distinguish the featured information region 16e from the product information region 16d. FIG. 8B provides a comparative view of a conventional retail battery pegboard display comprising pegs and prior art placard devices like those of FIG. 1B. As illustrated in the side-by-side comparison of FIGS. 8A and 8B, the featured information region 16e of the present invention provides a more visible display of information (e.g., product species information) to prospective consumers to assist in the location, selection and purchase of desired products. A few perceived benefits of the display are described further below.

Since consumers often have the featured information in mind when viewing a product display, providing a featured information region 16e that is physically and, optionally, visually distinct from the information on the rectangular product information region 16d not only helps consumers identify the product they want, it also helps consumers de-select (that is, disregard) similar products in the display that do not meet the consumers' needs. De-selection is facilitated because the consumer can quickly determine that the other, similar products are not the ones they want, despite visual similarity of the product or product package.

The product selection or de-selection processes are further enhanced by providing important product information (e.g., the product species information) of all the related products on a unique, common visual plane. Having the important information on a common plane facilitates a consumer's visual search on that plane. Since the information is presented on a plane that is separate from the product packages, any variability of the product packages does not distract the consumer or the retailer from finding the information. Without providing the information in a common plane, it would be necessary to look to the forward item on each peg, and the forward item on various pegs may be at different positions on the pegs (e.g., depths), leading to visual confusion.

The inventor has discovered that it is also helpful that the placards have uniform configurations so that the featured information appears at a consistent location on each placard. Providing consistency in the display of the featured information helps consumers and retailers in locating the information on each placard and helps in comparing featured information from one placard to the featured information on another placard. In addition, consistency of configuration of the placards for the display of featured information alleviates the visual confusion that arises in a display of interchangeable good when different manufacturers of those goods display the species information in different ways. For example, even among battery manufacturers who provide size information (e.g., “AA” battery size information) prominently on their battery packages, there are differences as to the location and the presentation of the information (color, font style and size, quadrant where the information is provided on the packaging, etc.) which makes a display based solely on product packages visually crowed and complex. As a result, a consumer could be misled into overlooking a product that would meet their needs. By presenting the information in a uniform manner, the product display avoids such crowded, complex and/or misleading displays of information.

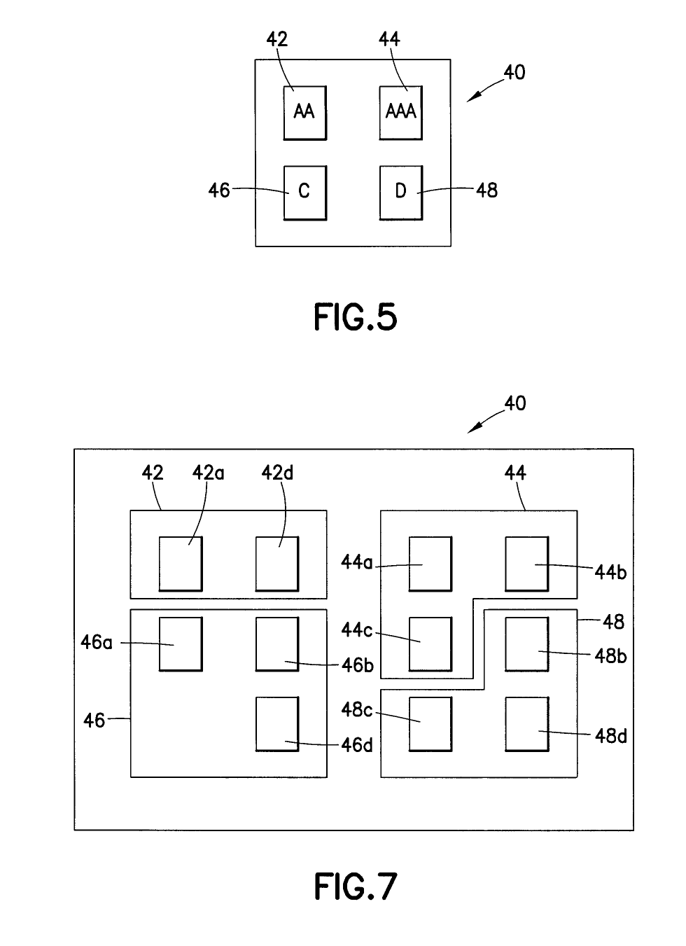

To create a product display, a retailer mounts peg displays 110 on a pegboard. When there are multiple pegs 110 for displaying products of the same species, the pegs 110 are preferably grouped together by product species. For example, as depicted in FIG. 5, a pegboard display 40 of a product line of batteries may have a first group 42 of AA battery peg displays, a second group 44 of AAA battery peg displays, a third group 46 of C battery peg displays, and a fourth group 48 of D battery peg displays. As is shown in FIG. 8A, the featured information region 16e particularly highlights individual species (differing battery sizes) within the product line of batteries.

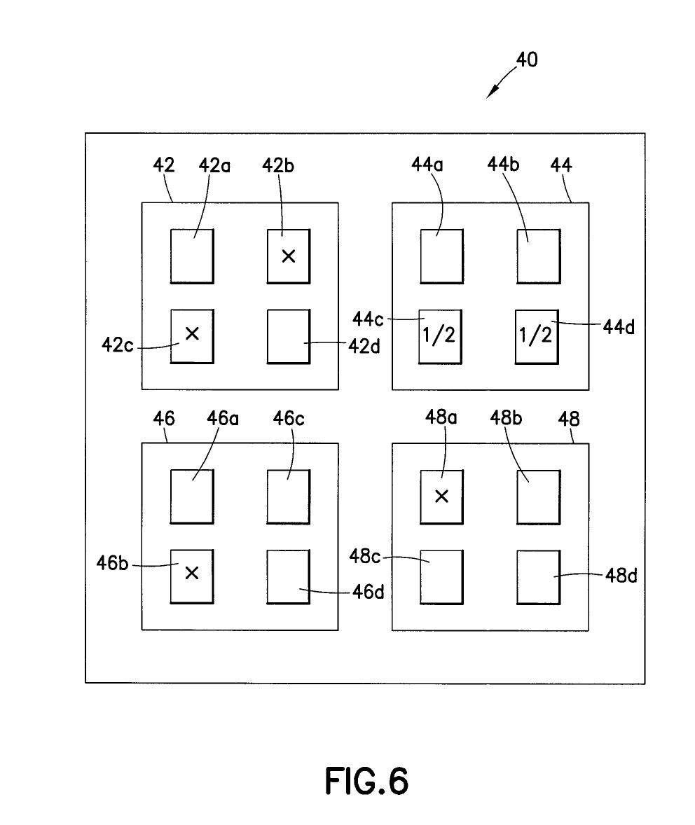

When a product display needs (or it is desired) to be rearranged on the pegboard, this is easily accomplished as well. For example, sales of particular batteries may result in the display 40 of FIG. 5 looking “unkempt” due to a relative emptiness in a particular region of the display 40. The emptiness may be due to the complete absence or partial absence of product on one or more pegs in the display 40. For example, each of groups 42, 44, 46 and 48 may comprise four peg displays a-d, respectively, as indicated in FIG. 6. After a number of sales, two displays of group 42 (42b, 42c) and one display in each of groups 46 and 48 (46b, 48a) are empty (indicated by “X's” in the FIG. 6), and two displays in group 44 (44c, 44d) may be half-full (as indicated by the “½” label). In such case, the retailer may wish to consolidate the goods on the display 40 to eliminate unattractive visual “holes” in the display. Consolidation may involve moving products from a partially empty peg (44d) to another partially empty peg (44c) and/or removing empty pegs (42b, 42c, 46c, 48a), and moving the remaining pegs into a more pleasing or user-friendly arrangement on display 40′ as indicated in FIG. 7. Prior art pegboard displays make such rearrangement tedious, and the result may confuse customers who were familiar with the initial configuration and who have trouble reading the product information on a prior art placard arm. However, the peg display assemblies featuring the placard arms as described herein make such rearrangements easy to perform and to use. For example, the featured information regions 16e make locating desired products within the product display relatively easy.

In addition to facilitating the initial selection of a product from a pegboard display and the rearrangement of the display, the use of a placard arrangement as described herein makes management of the product display easier for the retailer. Should it be necessary to move the products from one pegboard to another, the pegs with their accompanying placard arms are quickly and easily grouped together by hanging pegs having the same product species information together. Moreover, individually identifying species on each peg and placard arm arrangement allows a retailer to mix product species as they chose to maximize the use of precious retailer space without worrying that consumer confusion will follow from the mixing of product species and sales will be lost.

It should be appreciated that all of the foregoing advantages can be provided with a placard that does not detract from the usable display space on the pegboard. For example, in the embodiment shown, the featured information region 16e extends into a portion of the display system (e.g., between rows and columns of displayed products) that is otherwise not used and further would not impede retrieval of a product hanging on a peg.

It should be appreciated that while the inventive placard device 10 is described as included within a pegboard display system, it is within the scope of the present invention to provide such a placard device in other types of product display systems. For example, the inventor has realized that all product display systems can be improved by employing a placard having the inventive arrangement of a product information region and a featured information region as the arrangement permits a retailer to visually display product species within product lines having a variety of species of products. In a particular embodiment, the featured information region 16e can extend from the generally rectangular product information region 16d to a position that does not intrude into the display space for an adjacent peg and placard. For example, placards having the inventive arrangement of a product information region and a featured information region may be utilized on product display systems that include a shelving system with the placards affixed to a forward portion of each shelf. Each shelf is dedicated to a different species of product to provide a display for that species of product. Optionally, a shelf may have a plurality of portions of the shelf, each portion providing a display for a different species of product and having an associated placard device identifying each of the different species to prospective consumers.

In these ways, the present invention allows products to be quickly displayed in a user-friendly manner and in such a manner that store personnel and prospective consumers may quickly select an appropriate location or product within the location by reviewing the featured information region 16e without the need of carefully scrutinizing the collection of information in the typical rectangular product information region 16d. The retailer can therefore delegate the tasks of assembling, re-arranging and replenishing such displays to personnel with a minimum of training and no specialized tools.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A placard device comprising:
a placard having a product information region and a featured information region; and
an attachment device for mounting the placard device on a product support device.

2. The placard device of claim 1, wherein the product information region displays at least one of a product's manufacturer code, a scannable bar code, and textual information including the product's commercial name, price and size.

3. The placard device of claim 1, wherein the featured information region displays product species information.

4. The placard device of claim 1, wherein the featured information region is configured of at least one of a shape and a color to distinguish the featured information region and information displayed therein from the product information region and information displayed therein.

5. The placard device of claim 4, wherein the product information region is a rectangular shaped area and the featured information region is a circular pendant area disposed adjacent to the rectangular shaped area.

6. The placard device of claim 4, wherein the product information region is comprised of a first color and the featured information region is comprised of one of a plurality of colors each different from the first color.

7. The placard device of claim 6, wherein the plurality of colors of the featured information region corresponds to species information that distinguishes a feature of products within a line of products.

8. The placard device of claim 7, wherein the distinguishing feature includes at least one of a product's size, a product's type, promotional information, information identifying a product by the product's nutritional value, product rating or classification.

9. The placard device of claim 1, wherein the attachment device is comprised of a foot portion, and wherein the placard device further includes a boom portion joined to and extending outwardly from the foot portion, and wherein the placard is joined to a distal end the boom portion.

10. The placard device of claim 9, wherein the boom portion is joined to the foot portion and the placard is joined to the boom portion by hinges such that the foot portion and the placard each extend vertically downwardly from the boom portion.

11. The placard device of claim 9, wherein the product support device comprises a pegboard display system having a pegboard and at least one peg, and wherein the foot portion of the placard device is disposed about the at least one peg.

12. The placard device of claim 1, wherein the product support device comprises a shelving system.

13. A product display system comprising:
a pegboard;
a plurality of pegs disposed on the pegboard; and
a plurality of placard devices, one of the placard devices being associated with each of the pegs, wherein each placard device comprises a placard that includes a product information region and a featured information region.

14. The product display system of claim 13, wherein each placard device comprises a foot portion and a boom portion joined to the foot portion, wherein the placard is joined to the boom portion.

15. The product display system of claim 13, wherein the featured information region is configured of at least one of a shape and a color to distinguish the featured information region and information displayed therein from the product information region and information displayed therein.

16. The product display system of claim 15, wherein the product information region is a rectangular shaped area and the featured information region is a circular pendant area disposed adjacent to the rectangular shaped area.

17. The product display system of claim 13, wherein the product information region is comprised of a first color and the featured information region is comprised of one of a plurality of colors each different from the first color.

18. The product display system of claim 17, wherein the plurality of colors of the featured information region corresponds to species information that distinguishes a feature of products within a line of products.

19. The product display system of claim 17, wherein the distinguishing feature includes at least one of a product's size, a product's type, promotional information, information identifying a product by the product's nutritional value, product rating or classification.

20. A method of creating a product display system, comprising:
associating a plurality of placard devices with a product support device, wherein each of the placard devices comprises a placard having a product information region for displaying product information and a featured information region for prominently displaying product species information;
placing a plurality of products on the product support device, wherein the product bears product information that matches the product identification on the placard device; and
arranging the plurality of products on the product support device by grouping together products having common featured information.
